(19) United States
(12) Patent Application Publication
(10) Pub. No.: US 2014/0267615 A1
(43) Pub. Date: Sep. 18, 2014

(54) WEARABLE CAMERA

(71) Applicants: William F. Tapia, Weston, FL (US); Benjamin Pei-Ming Chia, Cupertino, CA (US); Stephen Hooper, Bellingham, WA (US); Yi-Chun Liao, Taichung City (TW)

(72) Inventors: William F. Tapia, Weston, FL (US); Benjamin Pei-Ming Chia, Cupertino, CA (US); Stephen Hooper, Bellingham, WA (US); Yi-Chun Liao, Taichung City (TW)

(21) Appl. No.: 13/839,733

(22) Filed: Mar. 15, 2013

(51) Int. Cl. H04N 5/225; H04N 13/02

(52) U.S. Cl. CPC H04N 5/2254; H04N 13/0203
USPC 348/46; 348/376

(57) ABSTRACT

An image capture system includes a camera including a processor, an imager coupled to a lens mounted on a substantially curved camera body, said curved camera body anatomically shaped for mounting to a forehead region; and a headband to secure the camera to the forehead to capture a picture or video.

This application is related to application Ser. Nos. ______; ______; ______, all filed concurrently herewith, the contents of which are incorporated by reference.

### BACKGROUND

The present invention relates to a wearable camera.

Since the beginning of photography and video, users and manufacturers have faced the problem of conveniently carrying, accessing, and using a camera under various operating conditions. The advent of digital cameras has made it easier to take action photographs or videos while participating in fast-paced physical activities such as surfing, snorkeling, skiing, mountain biking, kayaking, rafting, among others.

To accommodate photography/videography during such physical activities, digital camera manufacturers have produced cameras that are simple to operate, low cost, lightweight, and have compact form factors. These cameras can be secured using various mounts, harnesses, or straps to allow a user to keep one or more hands free for the physical activity. For example, camera wrist strap systems are available that provide a compact and lightweight camera together with a strap for securing the camera to a user's wrist. This configuration allows the user to easily access, operate, and then quickly secure the camera. Furthermore, the camera is small and light enough that it does not handicap the user while engaging in physical activity. Alternatively, helmet style camera systems allow a user to mount a compact and lightweight camera to a helmet. Other types of camera systems may include mounts for securing a camera to a bumper or windshield of a car to capture images or video while driving.

### SUMMARY

An image capture system includes a camera including a processor, an imager coupled to a lens mounted on a substantially curved camera body, said curved camera body anatomically shaped for mounting to a forehead region; and a headband to secure the camera to the forehead to capture a picture or video. The camera may be a low profile camera. The camera may capture 3D images and may capture normal or panoramic images.

Advantages of the camera may include one or more of the following. The camera includes a number of benefits and advantages. The camera can easily be used by a photographer to carry, access, and securely hold and use a camera even while participating in fast-paced board related activities such as surfing, snowboarding, skiing, and so on. Additionally, the camera mount will keep a camera attached to the board even if the user falls or encounters some circumstance that forces him or her to let go of the camera while taking a photograph/video. The mount can be easily used with a wide range of camera types, sizes, and dimensions and can likewise be adjusted to fit a wide range of users. Moreover, the mount may interoperate with other devices, for example, video cameras, binoculars, monoculars, cell phones, personal digital assistants, music players (e.g., Mp3 players or radio devices), game devices, and the like. Further still, such board-mounted camera will allow its user to take photographs or videos while participating in such activities that might otherwise have prohibited or made difficult the act of photography. Moreover, the camera is advantageously secured while providing quick access for the user to the device attached to the harness so that the user can, for example, move a camera from a front view in a secured position to the rear view secured position, take a photograph/video, and then re-secure the camera in the front view secured position. In addition, the system is advantageously configured so that the device, e.g., camera, remains secured to the harness even if the user is unable to return the device from the first secured position to the second secured position. The camera may be configured with fewer numbers of parts, and therefore, is more reliable due to fewer potential failure points and may be less expensive to manufacture. Further, the camera system may be configured using lightweight material and may also be configured for attaching to a wide range of boards such as snowboards and surfboards. Hence, the camera is advantageous for a wide range of potential users. The camera can easily be used by a photographer to carry, access, and securely hold and use a camera even while participating in fast-paced board related activities such as surfing, snowboarding, skiing, and so on.

### BRIEF DESCRIPTION OF THE DRAWINGS

FIG. 1A shows an exemplary camera with a curved body 300 that is anatomically geared for use on a user's forehead.

FIG. 1B shows an anatomically-correct wearable camera mount system.

FIGS. 1C-1D show the system of FIG. 1B secured to a user's head.

FIGS. 1E-1F show alternative embodiments of the wearable camera mount system.

FIG. 1G shows an exemplary headband embodiment of the wearable camera mount system.

FIG. 1H shows an exemplary process 20 for operating the anatomically correct head mounted camera to record images and videos while surfing.

FIG. 2A shows an exemplary visual feedback system for the camera, while FIG. 2B-2C show exemplary 3D cameras, and FIG. 2D show a camera with front and back lenses.

FIG. 3A shows an exemplary process for manual control of the camera.

FIG. 3B shows an exemplary display with left, right, mode, and record/stop buttons.

FIG. 3C shows an exemplary user interface for swapping modes with the mode button. The modes can be switched from video record, video playback, and music playing.

FIG. 3D shows an exemplary recording user command sequence.

FIG. 3E shows exemplary user commands to manage video contents, from recording to playing of video and deletion of videos.

FIG. 3F shows exemplary user commands to navigate a music player in the camera.

FIGS. 4A-4B shows an exemplary remote control camera.

FIGS. 5A-5B show another headmount embodiment, but with a head strap and a sunshield or visor that can be optionally mounted on the headmount.

FIG. 5C shows another camera embodiment with wide angle lens and a lanyard or carabiner securing system.

FIG. 6A shows an exemplary digital camera schematic.

FIG. 6B shows an exemplary remote watch schematic.

### DESCRIPTION

FIG. 1A shows an exemplary camera with a curved body 300 that is anatomically geared for use on a user's forehead. Although the disclosed embodiments secure a camera for surfing purposes, the camera can be used in various sports including sports that use a board, for example a surfboard, windsurfing board, kite surfing board, skateboard, snowboard, skis, or a wakeboard. The head-mounted camera is also useful for any type of sports including skiing, snowboarding, horse riding, snorkeling, skiing, mountain biking, kayaking, and rafting, among others. For ease of description, references will be made to a surfing, but the principles described herein are understood to be applicable to other sports.

The camera includes a moveable arm 310 that rotates out to expose one or more connectors 312 on either side of the camera body. The arm 310 can be a side rubber strip or other suitable materials that provide a seal or waterproof protection for the connectors 312 when the arm 310 is closed. The arm also allows the camera to stand on a desktop. The camera 300 has a lens 314 that is optimized for capturing surfing images or videos. In one embodiment, the lens 314 is fixed, and in another embodiment, a servomotor can adjust the focus for improved sharpness. In one embodiment, the camera can have two images to capture stereo or 3D images of the surfing experience. One or more buttons 316 is positioned on the body 300 to allow the user to control the camera such as to start and stop recording videos, among others. One or more openings 319 are positioned at each corner of the camera body 300 to allow the user to see the outputs of display devices such as LED displays. These displays may be turned on in a predetermined sequence to indicate that filming is on or that a setting has been selected, for example. A magnetic ring 318 is positioned at one end of the lens for subsequent attachment to a helmet, head band, or bandana to secure the camera to the head. Such helmets and bandanas require no effort in carrying the camera and are convenient for surfers to use while securing the camera to the surfer.

Turning now to FIG. 1B, an anatomically-correct wearable camera mount system is shown, while FIGS. 1C-1D show the system of FIG. 1B secured to a user's head. In this embodiment, a bandana houses the camera of FIG. 1A with a front portion 340 that is rotatably connected to a rear portion 342 at a joint with a pivot pin 344. The front portion 340 has extension arms 342 to allow the user to select the appropriate hole in the extension arm and adjust the size of the bandana to snugly fit the user's head. The front portion 340 has an opening to receive the camera lens 314 and a magnetic ring 348 that securely engages the ring 318 on the camera body 300. One or more pushbuttons 346 are provided on the front portion 340 that, when pushed by the user, makes mechanical contact with the corresponding pushbuttons 316 on the camera body 300.

Once the camera has been secured to the bandana, the bandana takes seconds to wear and adjust, yet it can support the camera in the perfect position for the entire surfing session, helping surfers to take great still and motion photography by preventing camera movement. The head-worn camera minimizes any camera movement while the shutter is open to reduce a blurred image. In the same vein, the bandana reduces camera shake, and thus are instrumental in achieving maximum sharpness.

The head-mount system allows a user to securely mount a camera to the head to capture images and/or video during activity involving the user without taking away from the user's ability to surf or participate in other similar activities. Beneficially, the mount provides a solid platform projecting from the user's head in a variety of positions and angles to allow for the capture of images (still and/or video) from the perspective of the surfer without camera shaking or other instability when taking videos.

In one embodiment, the bandana is a two-piece assembly, with a front portion 340 having an opening to receive the camera lens 314. Each portion can be molded from a single piece of flexible material containing a plurality of rigid elements integrally carried therein. The flexible multi-piece (such as 2, 3 or 4 pieces) bandana elements deform independently of each other to the extent required to conform to the wearer's head. The bandana is easily and inexpensively manufactured in a variety of forms to meet certain functional and esthetic requirements.

In other embodiments, instead of a bandana, a surfing cap, hood, or other close fitting clothing can be used. FIGS. 1E-1F show alternative embodiments of the wearable camera mount system. In these embodiments, a front pocket with zipper or other means of sealing the pocket is provided as a housing for the camera of FIG. 1A. The camera is inserted into the pocket and aligned so that the lens and the buttons are accessible through the ports on the pocket. FIG. 1G shows an exemplary headband embodiment of the wearable camera mount system. In the embodiment of FIG. 1G, the camera is inserted through a hole or access port on the back of the headband and aligned so that the lens and the buttons are accessible through the ports on the pocket.

The camera harness or mount system can easily be used by a photographer to carry, access, and securely hold and use a camera even while participating in fast-paced activities such as surfing, kayaking, rafting, snorkeling, skiing, and so on. Additionally, the camera mount/harness will keep a camera attached to the head of a user even if the user falls or encounters some circumstance that forces him or her to let go of the camera while taking a photograph/video. The camera mount can be easily used with a wide range of camera types, sizes, and dimensions and can likewise be adjusted to fit a wide range of users. Moreover, the camera mount may also be adapted for use with other devices, for example, video cameras, binoculars, monoculars, cell phones, personal digital assistants, music players (e.g., MP3 players or radio devices), game devices, and the like. Further still, the camera mount will allow its user to take photographs or videos while participating in such activities that might otherwise have prohibited or made difficult the act of photography. The camera mount may be configured from a lesser number of parts, and therefore, is more reliable due to fewer potential failure points and may be less expensive to manufacture. Further, the present invention may be configured using lightweight material and may also be configured for attaching to a wide range of user extremities or appendages, for example, a head, an arm, a wrist, a leg or an ankle, or even a non-appendages such as bicycle handlebars, hang glider control bars, a windsurfer boom, and so on. Hence, the camera is advantageous for a wide range of potential users. It is understood that any reasonable means for attaching, securing, or otherwise fastening a camera to a harness or strap can be substituted for any of the above mentioned methods of attaching a camera to the forehead.

FIG. 1H shows an exemplary process 20 for operating the anatomically correct head mounted camera 40 to record images and videos while surfing. The cam 40 is mounted on the head of the surfer 34 can stand or rest thereon. In this process, a remote control device such as a watch can be worn on the user to remotely control the camera. The user then inserts the camera 40 into a head-mount such as the bandana of FIG. 1B and secures the camera to the head in 22. Any adjustment to camera worn angle can be done using the remote watch or using a suitable display on the camera. In 26, the surfer goes out to the water and starts recording in 28. The surfer enjoys the wave in 30 and when done stops the recording in 32.

Turning to FIG. 2A, an exemplary visual feedback system is shown for the camera 40. The camera 40 includes one or more visual feedback devices 42 such as LEDs. A plurality of buttons are 44 and 46 are provided to receive commands from the surfer. A lens 50 captures light and focuses the image onto an imager inside the camera 40. In this process, one exemplary visual feedback sequence can include the following: constant on to indicate recording, flash 3 times to indicate device turning off, flashing light to indicate Bluetooth communication, low battery or low memory. If the device has a problem, the light can show alternating colors.

FIG. 2B shows an exemplary 3D camera with two lenses placed side by side for stereoscopy. Stereoscopy creates the illusion of three-dimensional depth from given two-dimensional images. Human vision, including the perception of depth, is a complex process which only begins with the acquisition of visual information taken in through the eyes; much processing ensues within the brain, as it strives to make intelligent and meaningful sense of the raw information provided. One of the very important visual functions that occur within the brain as it interprets what the eyes see is that of assessing the relative distances of various objects from the viewer, and the depth dimension of those same perceived objects. The brain makes use of a number of cues to determine relative distances and depth in a perceived scene. The two cameras allow the images to be played using a 3D viewing software to provide a 3D video experience.

FIG. 2D shows a camera with front and back lenses. The front camera can capture stills with 16 megapixels, record video at 1080p resolution and has a large f/2.0 aperture for better performance in low light. All that adds up to better surfing portraits and improved video capture. The front camera has a wide-angle ability that captures up to triple the area of other front-facing cameras—making sure the user can get more of the surfing entourage in group shots. The back camera can be used for commenting or taking rear images simultaneously.

FIG. 3A shows an exemplary process for manual control of the camera. In this process, the user performs pre-surf preparation such as charging the battery and clearing memory cards (60). Shortly before surfing, the user inserts fresh battery and empty memory card into the camera 40 and then mounts the camera on the surfboard (62). The user swims to a spot and waits for a wave (64). Meanwhile, he or she can listen to music or watch previous surf sessions on a camera screen (66). When the right wave approaches, the user presses a record button to start recording (68) and surfs the wave (70). When done, the user presses the stop button to stop the recording session (72). The user can preview the captured videos on the screen of the camera (74). Upon finishing the surf session (76), the user can upload images and videos to a computer (78). The battery and memory card can be removed (80) for recharging and data loading, respectively (82). The files are transferred for editing for uploading to a web site for social networking or sharing purposes (84).

FIG. 3B shows an exemplary display with left, right, mode, and record/stop buttons. FIG. 3C shows an exemplary user interface for swapping modes with the mode button. The modes can be switched from video record, video playback, and music playing. FIG. 3D shows an exemplary recording user command sequence. FIG. 3E shows exemplary user commands to manage video contents, from recording to playing of video and deletion of videos. FIG. 3F shows exemplary user commands to navigate a music player in the camera.

The UI of FIGS. 3A-3F can be provided on the back of the camera if it has a display. Alternatively, if the camera does not have a built-in display, the UI can be provided on a remote control camera such as the camera of FIGS. 4A-4B.

FIGS. 5A-5B show another headmount embodiment, but with a head strap and a sunshield or visor that can be optionally mounted on the headmount. FIG. 5C shows another camera embodiment with wide angle lens and a lanyard or carabiner securing system.

FIG. 6A shows an exemplary camera schematic. A processor 502 communicates over a bus with memory such as RAM 504 and ROM 506. The processor (CPU) 502 also communicates with a USB transceiver 508 to allow the user to transfer data from memory to a remote computer. The processor 502 also communicates with a wireless transceiver 510 such as Bluetooth to allow wireless data transfer with the remote phone, tablet or computer. In one embodiment, the camera is completely sealed to provide waterproofing. In another embodiment, the camera has a flash memory receptacle 507 that allows common flash modules to be inserted into the camera to provide high capacity video storage and expandability. The CPU 502 also controls a servo motor 512 to adjust the focus of the lens 318. Light captured by an image sensor 500 is processed by the CPU 502. Additionally, one or more displays 514 can be driven by the CPU 502. In one embodiment, the displays 514 can be LEDs positioned at four corners of the camera to provide visual feedback to the surfer. In another embodiment, an OLED display can be provided to show the user the image or video being captured.

The image sensor 500 can be a charge coupled device (CCD) or a complementary metal oxide semiconductor (CMOS) device. Both CCD and CMOS image sensors convert light into electrons. Once the sensor converts the light into electrons, it reads the value (accumulated charge) of each cell in the image. A CCD transports the charge across the chip and reads it at one corner of the array. An analog-to-digital converter (ADC) then turns each pixel's value into a digital value by measuring the amount of charge at each photo site and converting that measurement to binary form. CMOS devices use several transistors at each pixel to amplify and move the charge using more traditional wires. The CPU 502 can be a low power processor such as an ARM processor and can run Android as an embedded operating system in one embodiment.

The camera body 300 may also include a battery to supply operating power to components of the system including the processor, ROM/RAM, flash memory, input device, microphone, audio transducer, H.264 media processing system, and sensor(s) such as accelerometers and GPS unit.

The processor controls the image processing operation; and, it controls the storage of a captured image in storage device such as RAM or flash. The processor also controls the exporting of image data (which may or may not be color corrected) to an external general purpose computer or special purpose computer. The processor also responds to user commands (e.g., a command to “take” a picture or capture video by capturing image(s) on the image sensor and storing the image(s) in memory or a command to select an option for contrast enhancement and color balance adjustment). Such commands may be verbal and recognized through speech recognition software, or through the remote watch 400. In one embodiment, the processor can be an ARM processor with integrated graphical processing units (GPUs). The GPUs can perform panorama stitching so that 3 inexpensive cameras can be used to provide a 180 degree immersive view.

In some embodiments, the processor is configured to continuously capture a sequence of images; to store a predetermined number of the sequence of images in a buffer, to receive a user request to capture an image; and to automatically select one of the buffered images based on an exposure time of one of the buffered images. The sequence of images may be captured prior to or concurrently with receiving the user request. The processing system while automatically selecting one of the buffered images is further configured to determine an exposure time of one of the buffered images, determine whether the exposure time meets predetermined criteria based on a predetermined threshold exposure time, and select the most recent image if the exposure time meets the predetermined criteria. The processing system is also configured to initiate the continuously capturing and the storing after the data processing system enters an image capture mode. While automatically selecting one of the buffered images, the processor can determine a focus score for each buffered image and to select a buffered image based on the focus score if the exposure time fails to meet the predetermined criteria. The processing system while selecting a buffered image based on the focus score is further configured to determine a product of the focus score and the weighted factor for each of the buffered images and select a buffered image having a highest product if the exposure time fails to meet the predetermined criteria.

FIG. 6B shows an exemplary remote control wristwatch schematic. A processor 552 communicates over a bus with memory such as RAM 554 and ROM 556. The processor (CPU) 552 also communicates with a USB transceiver 558 to allow the user to transfer data from memory to a remote computer. The USB port can also be used for charging a battery that powers the watch. The processor 552 also communicates with a wireless transceiver 560 such as Bluetooth to allow wireless data transfer with the camera's processor 502. A display 564 can be driven by the CPU 502. In one embodiment, the display 564 can be an OLED display to show the user the image or video being captured by the image sensor 500, for example.

The wristwatch and the camera can use H.264 encoder and decoder to compress the video transmission between the units. H.264 encoding can be essentially divided into two independent processes: motion estimation and compensation, and variable length encoding. The motion estimation sub module of the core consists of two stages: integer pixel motion estimation followed by a refining step that searches for matches down to ¼ pixel resolution. The integer search unit utilizes a 4 step search and sums of absolute difference (SAD) process to estimate the motion vector. Similar to the case of motion estimation, SADs are used to search for the intra prediction mode that best matches the current block of pixels. The resultant bitstream is assembled into NAL units and output in byte stream format as specified in Annex B of the ITU-T H.264 specification. In the encoder, the initial step is the generation of a prediction. The baseline H.264 encoder uses two kinds of prediction: intra prediction (generated from pixels already encoded in the current frame) and inter prediction (generated from pixels encoded in the previous frames). A residual is then calculated by performing the difference between the current block and the prediction. The prediction selected is the one that minimizes the energy of the residual in an optimization process that is quite computationally intensive. A linear transform is then applied to the residual. Two linear transforms are used: Hadamard and a transform derived from the discrete cosine transform (DCT). The coefficients resulting from the transformations are then quantized, and subsequently encoded into Network Abstraction Layer (NAL) units. These NALs include context information—such as the type of prediction—that is required to reconstruct the pixel data. The NAL units represent the output of the baseline H.264 encoding process. Meanwhile, inverse quantization and transform are applied to the quantized coefficients. The result is added to the prediction, and a macroblock is reconstructed. An optional deblocking filter is applied to the reconstructed macroblocks to reduce compression artifacts in the output. The reconstructed macroblock is stored for use in future intra prediction and inter prediction. Intra prediction is generated from unfiltered reconstructed macroblocks, while inter prediction is generated from reconstructed macroblocks that are filtered or unfiltered. Intra prediction is formed from pixels that were previously encoded. Two kinds of intra predictions are used: intra16×16 and intra4×4. In intra16×16, all the pixels already encoded at the boundary with the current block can be used to generate a prediction. These are shown shaded in the figure below. The core can generate the four modes of the intra16×16 prediction. In intra4×4, 16 4×4 blocks of prediction are generated from the pixels at the boundaries of each 4×4 prediction block and boundary pixels are used in intra16×16 and intra4×4 intra prediction modes. The inter prediction is generated from motion estimation. At the heart of video compression, motion estimation is used to exploit the temporal redundancy present in natural video sequences. Motion estimation is performed by searching for a 16×16 area of pixels in a previously encoded frame so that the energy of the residual (difference) between the current block and the selected area is minimized. The core can search an area 32×32 pixels wide, down to ¼ pixel of resolution (−16.00, +15.75 in both X and Y direction). Pixels at ¼ resolution are generated with a complex interpolation filter described in the ITU-T H.264 specification. The Hadamard transform and an integer transform derived from the DCT and their descriptions can be found in the ITU-T H.264 standard, the content of which is incorporated by reference. Both transforms (and their inverse functions) can be performed by using only additions, subtractions and shift operations. Both quantization and its inverse are also relatively simple and are implemented with multiplication and shifts.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Those of skill in the art will understand the wide range of structural configurations for one or more elements of the present invention. For example, certain elements may have square or rounded edges to give it a particular look. Further, particular elements of the present invention that are joined or attached to one another in the assembly process can be made, molded, machined, or otherwise fabricated as a single element or part. In addition, certain elements of the present invention that are fabricated as a single element or part can be fabricated as separate elements or in a plurality of parts that are then joined or otherwise attached to one another in the assembly process. Certain elements of the present invention that are made of a particular material can be made of a different material to give the device a different appearance, style, weight, flexibility, rigidity, reliability, longevity, ease of use, cost of manufacture, among others.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

While the above description contains much specificity, these should not be construed as limitations on the scope, but rather as an exemplification of preferred embodiments thereof. Accordingly, the scope of the disclosure should be determined not by the embodiment(s) illustrated, but by the appended claims and their legal equivalents.

What is claimed is:

1. An image capture system, comprising:
a camera including a processor, an imager coupled to a lens mounted on a substantially curved camera body, said curved camera body anatomically shaped for mounting to a forehead region; and
a headband to secure the camera to the forehead to capture a picture or video.

2. The system of claim 1, wherein the camera comprises a three-dimensional (3D) camera.

3. The system of claim 2, comprising two lenses positioned spaced apart on a body of the camera, each directing light to a separate imager.

4. The system of claim 2, comprising computer readable code to compress 3D content.

5. The system of claim 1, wherein the headband comprises a multi-piece bandana.

6. The system of claim 1, wherein the camera comprises an accelerometer.

7. The system of claim 1, wherein the camera comprises a body having one or more visual feedback devices on the body, wherein the headband provides visual feedback accesses.

8. The system of claim 1, comprising a low profile camera body.

9. The system of claim 1, comprising computer readable code to share content with a network.

10. The system of claim 1, comprising computer readable code to play music on the camera.

11. A system for capturing a surfing experience, comprising:
a camera having an anatomically shaped body fitting a forehead;
a wearable bandana or strap to mount the camera therein; and
a web server coupled to the camera to render pictures or videos during a surf session.

12. The system of claim 11, comprising a wireless link between the camera and a remote device to transfer content.

13. The system of claim 11, wherein the camera comprises a low profile board mounted camera.

14. The system of claim 11, wherein the wireless link transfers compressed images or videos from the camera to the remote watch and decompressing the images or videos for display on the remote watch.

15. The system of claim 11, wherein the camera is a 3D camera.

16. The system of claim 11, comprising computer code for constantly capturing images and using the remote to save a predetermined image.

17. The system of claim 11, comprising computer code to capture a panoramic image of surfing activities.

18. The system of claim 11, comprising computer code to preview an image or video on the remote watch and adjust the camera position to take a desired image or video.

19. The system of claim 11, comprising a water-resistant camera body.

20. The system of claim 11, wherein the camera includes a music library.
